(19) United States
(12) Patent Application Publication
(10) Pub. No.: US 2024/0416286 A1
(43) Pub. Date: Dec. 19, 2024

(54) MEMBRANE BUNDLE FOR VACUUM MEMBRANE DISTILLATION AND METHOD FOR MAKING SAME

(71) Applicant: KMX Technologies, Inc, Wilmington, DE (US)

(72) Inventors: Seyed B. SADR GHAYENI, Montreal (CA); Abd-Elghani HAMITI, Burlington (CA)

(21) Appl. No.: 18/662,224

(22) Filed: May 13, 2024

Related U.S. Application Data
(60) Provisional application No. 63/466,561, filed on May 15, 2023.

(51) Int. Cl. B01D 63/04; B01D 61/36; B01D 65/00

(52) U.S. Cl. CPC B01D 63/046; B01D 61/364; B01D 65/003; B01D 2313/02; B01D 2313/21

(57) ABSTRACT

A vacuum membrane distillation module includes a center core; a plurality of hollow fiber membranes; an shell which cylindrically houses the bundle of hollow fiber membranes and the center core; at least one circumferential retaining structures retaining the ends of the plurality of hollow fiber membrane; at least one end cap housing the at least one circumferential retaining structures; at least one supporting rod extending in a longitudinal direction; a potting material, which is contained between (i) an inner boundary formed by the outer surface of the center core, and (ii) a peripheral boundary formed by the inner surface of the least one circumferential retaining structure; and at least one of (i) the outer surface of the at least one end section of the center core and (ii) the inner surface of the least one circumferential retaining structure comprises an adaptation to enhance strength of bonding with the potting material.

### RELATED APPLICATIONS

This application claims priority of U.S. Provisional Application No. 63/466,561 filed May 15, 2023 the entire contents of which is incorporated herein by reference.

### TECHNICAL FIELD

The disclosure relates to the field of membrane-based systems for separating dissolved substances from water.

### BACKGROUND

Applicant's co-pending application PCT/US2022/051634 describes a vacuum membrane distillation module comprising a housing and a removable bundle of hollow fiber membranes. In use, feed water enters the module at the bottom and is conducted through a center core to the top of the module where it is distributed to enter the lumens of the hollow fiber membranes at their top ends. During vacuum membrane distillation, water vapor passes through the membranes to a permeate side from where it is drawn out of the module under vacuum for condensation and collection. Salts present in the feed water are retained in the liquid within the lumen side of the hollow fiber membranes and form a concentrate stream which exits the module at the bottom.

The membrane bundle comprises a plurality of longitudinally disposed, generally parallel hollow fiber membranes arranged around the center core. The hollow fiber membranes and the center core are secured at each end by a membrane boot filled with a potting material. An end section of the fiber membrane bundle and of the center core spans the potting material contained in a respective membrane boot such that the open end of the hollow fiber membrane is exposed at a surface of the potting material. The lumen of the center core is similarly exposed at the top surface of the potting material of the top membrane boot, fluidly connecting the feed water inlet with the space defined by a module top cap.

The potting material of the membrane boots is laterally contained in a space between an inner circumference defined by the center core and an outer circumference defined by a membrane boot.

In the vacuum membrane distillation process, it is crucial to prevent leakage of raw feed water from the feed side of the membranes to the permeate side, which would contaminate the purified water on the permeate side and render the module inoperable such that the membrane bundle would have to be removed and repaired or replaced.

The membrane boot, specifically the potting material, separates the feed water side of the system from the permeate side. To perform this function, it is required to effect a robust watertight seal between the potting material and the fibers and between the potting material and the parts containing the potting material, i.e., the membrane boot and the center core. The inventors have previously determined that chemical bonding between the potting material and the fibers, as can be achieved with epoxy potting materials, provides a superior, more durable seal than a mechanical bond such as gripping the fibers by compression of the potting material.

In certain conditions, using prior art embodiments, the seal between the potting material and the center core or between the potting material and the membrane boot can fail, as illustrated in FIGS. 1 and 2 where failure of the seal between the potting material and the center core has allowed leakage of feed water to the permeate side and consequent failure of the module.

FIG. 1 is a photograph showing a top view of a VMD membrane bundle 1 of a prior art design. A gap 2 of a few millimeters has formed between the center core 3 and the potting material 4, causing leakage from the center core. From this photo it is evident that the center core 3 has receded away from potting material 4 by a few millimeters, which caused substantial leakage of feed water from center core to the permeate side of the hollow fiber membranes 5 and consequent failure of the module.

FIG. 2 is a photograph showing an inverted view of the bottom end of a VMD membrane bundle 1 of a prior art design, where it is installed into the VMD module. Shifting of the feed water inlet 6 (which attaches to center core 3—not visible in FIG. 2, but shown in FIG. 1) the outside is apparent. Glue 7 is visible in excess around the feed water inlet 6 and center core (3, FIG. 1) where it has been applied in an unsuccessful attempt to prevent rotation of the water inlet 6 and center core 3 relative to potted hollow fiber membranes 5. This photo shows shifting of the feed water inlet 6 and towards outside. The glue 7 visible around the center core was applied in an attempt to fix the rotation of the center core against potted fibers. However, it was not successful.

The inventors have discovered that the seal between the potting material and the center core or between the potting material and the membrane boot can still fail, allowing leakage of feed water to the permeate side and consequent failure of the module.

Accordingly, there is a need to improve the robustness and durability of the seal between the potting material those parts containing the potting material.

### BRIEF SUMMARY OF THE DISCLOSURE

It has now been determined that the performance of the seal between a potting material and a center core or between the potting material and the membrane boot can be greatly enhanced by a design in which end sections of the center core are adapted for enhanced bonding with epoxy potting materials.

Accordingly, in a first aspect, the disclosure provides a vacuum membrane distillation module comprising hollow fiber membranes, the ends of which are secured in a potting material, the potting material contained between an inner boundary formed by an outer surface of a center core, and a peripheral boundary formed by an inner surface of at least one circumferential retaining structure, wherein at least one of an outer surface of an end section of the center core and the inner surface of the least one circumferential retaining structure is adapted to enhance strength of bonding with a potting material. Suitably, the potting material is an epoxy material.

The at least one circumferential retaining structure may be the shell or vessel of the vacuum membrane distillation module. Alternatively, the vacuum membrane distillation module comprises a membrane bundle assembly that is removable from the vacuum membrane distillation module and the at least one circumferential retaining structure is a membrane boot.

Accordingly, in a second aspect, the disclosure provides a membrane bundle for a vacuum membrane distillation module wherein at least one of an outer surface of an end section of the center core and the inner surface of a membrane boot is adapted to enhance strength of bonding with a potting material. Suitably, the potting material is an epoxy material.

Preferably, both end sections of the center core are adapted to enhance strength of bonding with epoxy potting material. More preferably, the center core end section and the membrane boot are adapted to enhance strength of bonding with epoxy potting material.

In one embodiment, the conformation of the center core end section and/or the membrane boot is adapted to increase the surface area of the center core available for contact with the potting material.

In one embodiment, the end section of the center core is formed with a threaded outer surface for engagement with the potting material, which provides both an increased surface area for contact with the potting material compared to a smooth cylindrical surface and also a peak-and-valley profile for enhanced engagement between the center core and the potting material which provides resistance to movement of the center core relative to the potting material. Correspondingly, the membrane boot may be formed with a threaded inner surface.

In another embodiment, the surface of the end section of the center core is formed with apertures allowing penetration of the potting material, which again provides an increased surface area for contact with the potting material and a non-smooth profile for enhanced engagement between the center core and the potting material which provides resistance to movement of the center core relative to the potting material. Correspondingly, the inner surface of membrane boot may be formed with apertures.

In another embodiment, the surface of the end section of the center core may comprise a coating comprising a porous material to facilitate ingress or absorption of potting material. Correspondingly, the inner surface of membrane boot may comprise a coting comprising a porous material.

Two or more of the approaches described herein may be combined for additional effect, e.g., apertures may be defined on a threaded surface.

The disclosure further provides a vacuum membrane distillation module comprising a membrane bundle as disclosed herein.

In another aspect, the disclosure provides a method for making a hollow fiber membrane bundle for use in a vacuum membrane distillation module, the membrane bundle comprising a plurality of hollow fiber membranes having first ends and second ends, the hollow fiber membranes being secured at each end in a membrane boot comprising a potting material radially contained within a space defined by the inner surface of a membrane boot and an outer surface of a central core, the method comprising a step of forming at least one of the inner surface of a membrane boot and the outer surface of a central core with a conformation to increase the engagement with the potting material.

The surface may be one or more of: threaded, formed with apertures, or comprise a coating comprising a porous material.

In still another aspect, the disclosure provides: a vacuum membrane distillation module comprising: an elongate center core having a first longitudinal axis; a plurality of elongate hollow fiber membranes having a second longitudinal axis substantially coaxial with, or substantially parallel to, the first longitudinal axis of the elongate center core, an elongate shell which cylindrically houses the elongate bundle of hollow fiber membranes and the elongate center core, wherein the elongate shell has a third longitudinal axis substantially coincident with, or substantially parallel to, the first longitudinal axis of the elongate center core, at least one circumferential retaining structure that retains at least one end of the plurality of elongate hollow fiber membranes; at least one end cap retaining the at least one circumferential retaining structures; at least one supporting rod extending in a longitudinal direction; a potting material, wherein the potting material is contained between (i) an inner boundary formed by an outer surface of the center core, and (ii) a peripheral boundary formed by the inner surface of the least one circumferential retaining structure; a plurality of generally longitudinal hollow fiber membranes, wherein ends of the plurality of hollow fiber membranes are secured in the potting material, and wherein at least one of (i) the outer surface of at least one end of the elongate center core and (ii) the inner surface of the at least one circumferential retaining structure comprise an adaptation to enhance bonding with the potting material.

In yet another aspect, the disclosure provides a vacuum membrane distillation module comprising: a center core having at least one end section; at least one circumferential retaining structure; at least one end cap; at least one supporting rod engaged with the at least one end cap to provide mechanical stiffness in a longitudinal direction; a potting material, wherein the potting material is contained between (i) an inner boundary formed by an outer surface of the center core, and (ii) a peripheral boundary formed by an inner surface of the at least one circumferential retaining structure; a plurality of generally longitudinal hollow fiber membranes, wherein ends of the plurality of hollow fiber membranes are secured in the potting material, and wherein at least one of (i) an outer surface of the at least one end section of the center core and (ii) the inner surface of the least one circumferential retaining structure comprises an adaptation to enhance strength of bonding with the potting material.

In yet another embodiment, the disclosure provides a vacuum membrane distillation module comprising: an elongate center core; housed within an elongate bundle of hollow fiber membranes; housed within, a module top cap longitudinally spaced apart from a module bottom cap; the foregoing housed within, a substantially cylindrical shell; wherein longitudinal axes of the center core, the elongate bundle of hollow fiber membranes, the module top cap, the bottom cap and the substantially cylindrical shell all have substantially coincident or substantially parallel longitudinal axes.

In this exemplary embodiment or another exemplary embodiment, the vacuum membrane distillation module comprises at least two, at least three, at least four at least five, at least six or at least seven supporting rods engaged with the at least one end cap. In this exemplary embodiment or another exemplary embodiment, the potting material is an epoxy material. In this exemplary embodiment or another exemplary embodiment, the adaptation comprises at least one of threads and apertures. In this exemplary embodiment or another exemplary embodiment, the adaptation comprises threads and apertures. In this exemplary embodiment or another exemplary embodiment, the apertures perforate the threads. In this exemplary embodiment or another exemplary embodiment, the apertures are generally perpendicular to the threads. In this exemplary embodiment or another exemplary embodiment, the peripheral boundary formed by an inner surface of at least one circumferential retaining structure comprises a membrane boot. In this exemplary embodiment or another exemplary embodiment, the least one circumferential retaining structure is a shell or a vessel of the vacuum membrane distillation module. In this exemplary embodiment or another exemplary embodiment, the plurality of hollow fiber membranes is housed in a membrane bundle assembly that is removable from the vacuum membrane distillation module and wherein the least one circumferential retaining structure is a membrane boot.

In still another aspect, the disclosure provides a membrane bundle for a vacuum membrane distillation module wherein at least one of an outer surface of an end section of the center core and an inner surface of a membrane boot comprises an adaptation to enhance bonding with a potting material.

In this exemplary embodiment or another exemplary embodiment, the adaptation is at least one of apertures and threads. In this exemplary embodiment or another exemplary embodiment, the adaptation is apertures and threads. In this exemplary embodiment or another exemplary embodiment, the potting material is an epoxy material. In this exemplary embodiment or another exemplary embodiment, the inner surface of membrane boot is provided with apertures within a threaded surface.

In yet another aspect, the disclosure provides a method for making a hollow fiber membrane bundle for use in a vacuum membrane distillation module, the membrane bundle comprising a plurality of hollow fiber membranes having first ends and second ends, the hollow fiber membranes being secured at the first ends in a first membrane boot and at the second ends in a second membrane boot, wherein first membrane boot and second membrane boot comprise a potting material contained between an inner surface of a respective membrane boot and an outer surface of a central core, the method comprising: (a) provide the plurality of hollow fiber membranes; (b) extend the plurality of hollow fiber membranes in a longitudinal direction; (c) provide the first membrane boot and the second membrane boot; (d) provide a potting material; € arrange first membrane boot and second membrane boot and the plurality of hollow fiber membranes wherein the first membrane boot and second membrane boot contain the first and second ends of the plurality of hollow fiber membranes; and (f) wherein the first membrane boot and second membrane boot are at least partially filled with the potting material to secure the plurality of hollow fiber membranes within said first membrane boot and said second membrane boot.

In this exemplary embodiment or another exemplary embodiment, the method further comprises: form at least one of the inner surface of a membrane boot and an outer surface of a central core with a conformation to increase the engagement with the potting material. In this exemplary embodiment or another exemplary embodiment, the conformation is selected from apertures and threads. In this exemplary embodiment or another exemplary embodiment, the conformation is coated with a porous material.

In this exemplary embodiment or another exemplary embodiment, the potting material engages with at least one of apertures and threads and a portion of membrane pores to form bonded potting material through the at least one of apertures, threads and pores.

### BRIEF DESCRIPTION OF THE DRAWINGS

FIG. 1 is a top perspective view of a vacuum membrane distillation (VMD) membrane bundle of a prior art design, with the module top cap removed.

FIG. 2 is an inverted bottom perspective view of a VMD membrane bundle of a prior art design.

FIG. 3 is a longitudinal cross-section of a membrane distillation module showing module shell, fiber bundle with module top cap, and bottom module cap.

FIG. 3A is a detailed view of FIG. 3 showing the module top cap and

threads.

FIG. 3B is a detailed view of FIG. 3 showing the bottom cap and threads.

FIG. 4 is an exploded view of the VMD membrane bundle of FIG. 3.

FIG. 5A is a perspective view of a center core of the disclosure.

FIG. 5B is a top plan view of a center core of the disclosure.

FIG. 5B-1 is an end view of a center core of the disclosure.

FIG. 5C is a cross section through line 5C-5C of FIG. 5B.

FIG. 5D is an expanded view of Detail 5D of FIG. 5C.

FIG. 5E is an expanded view of Detail 5E of FIG. 5C.

FIG. 6A is a perspective view of a disclosed retaining ring.

FIG. 6B is a top view of a disclosed retaining ring.

FIG. 6C is a side elevation of a disclosed retaining ring.

FIG. 6D is a bottom view of a disclosed retaining ring.

FIG. 6E is an expanded view of Detail E of FIG. 6B.

FIG. 6F is a sectional view through line 6F-6F in FIG. 6C.

FIG. 6G is an expanded view of Detail 6G of FIG. 6F.

FIG. 6H is an expanded view of Detail 6H of FIG. 6F.

FIG. 7A is a perspective view of a center core of the disclosure.

FIG. 7B is a top plan view of a center core of the disclosure.

FIG. 7B-1 is an end view of a center core of the disclosure.

FIG. 7C is a cross section through line 7C-7C of FIG. 7B.

FIG. 7D is an expanded view of Detail 7D of FIG. 7C.

FIG. 7E is an expanded view of Detail 7E of FIG. 7C.

FIG. 7F is an expanded view of Detail 7F from FIG. 7B-1.

FIG. 8A is a perspective view of a disclosed retaining ring.

FIG. 8B is a top view of a disclosed retaining ring.

FIG. 8C is a side elevation of a disclosed retaining ring.

FIG. 8D is a bottom view of a disclosed retaining ring.

FIG. 8E is an expanded view of Detail 8E in FIG. 8B.

FIG. 8F is an expanded view of Detail 8F in FIG. 8D.

FIG. 8G is an expanded view of Detail 8C in FIG. 8G.

FIG. 8H is an expanded view of Detail 8H in FIG. 8G.

FIG. 8I is an expanded view of Detail 8I in FIG. 8G.

FIG. 9 shows a partial sectional perspective view of a membrane bundle according to the disclosure.

FIG. 10A is a top plan view of a center core of the disclosure coated with porous thermoplastic material.

FIG. 10A-1 is an end view of a center core of FIG. 10A.

FIG. 10B is a cross section through line 10B-10B of FIG. 10A.

FIG. 10C is an expanded view of Detail 10C of FIG. 10B.

FIG. 11A is a side elevation of the membrane module of the disclosure.

FIG. 11B is a sectional view along line 11B-11B of FIG. 11A.

FIG. 11C is an expanded view of Detail 11C of FIG. 11B.

Similar numbers refer to similar parts throughout the drawings.

### DETAILED DESCRIPTION

To the accomplishment of the foregoing and related ends, certain illustrative aspects are described herein in connection with the following description and drawings. These aspects are indicative of the various ways in which the principles disclosed herein can be practiced. Other advantages and features will become apparent from the following detailed description when considered in conjunction with the drawings.

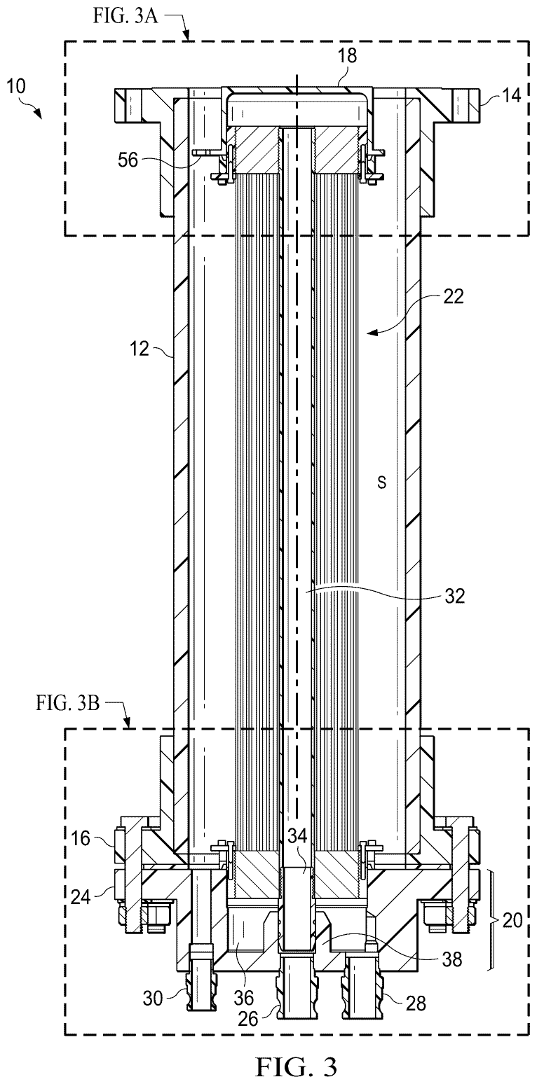

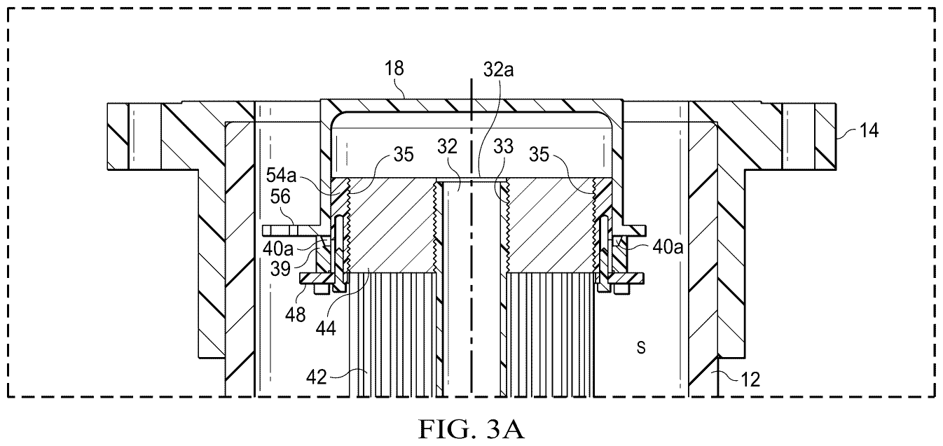

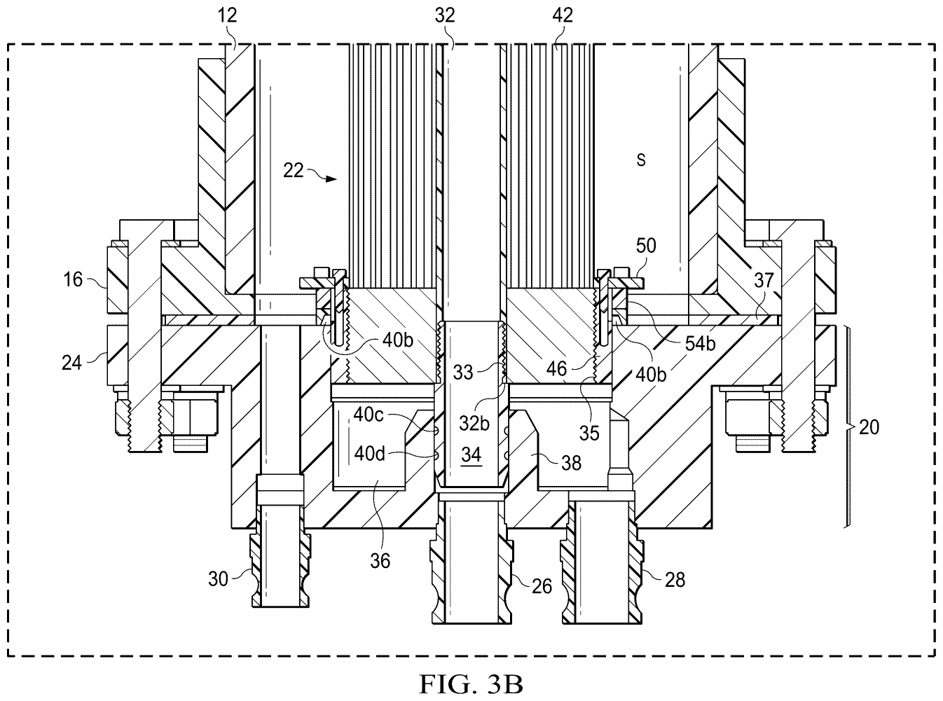

FIG. 3 depicts a longitudinal cross-section of a membrane distillation module 10 (HFDM-Hollow Fiber Distillation Module or just “Module”) showing module shell 12, fiber membrane bundle 22 with module top cap 18, and module bottom cap 20. Module 10 is suitable for receiving the fiber membrane bundle 22 of the present disclosure. The module includes a housing comprising a module shell 12 (“vessel body”) having a module top flange 14 and a module bottom flange 16 at top and bottom ends, respectively, of module shell 12. Each flange may be manufactured from an engineered plastic and is connected to the vessel body via a chemical welding, fusing or gluing process. FIG. 3A is an expanded view of FIG. 3 showing Detail 3A: the module top cap 18 and threads. FIG. 3B is an expanded view of FIG. 3 showing Detail 3B: the module bottom cap 20 and threads 33.

FIG. 3A is an expanded view of Detail 3A of FIG. 3 showing the shell 12, with flange 14; threads 33 on the outer diameter of a center core 32; and threads 35 on the inner diameter of module top cap 18. Center core 32 may have various cross sections such as triangular, square, pentagonal, ellipsoidal, or circular. It is preferred that center core 32 has a circular cross section, making center core 32 a cylinder. Upper boot flange 48 supports module top cap 18 which is threadedly engaged therewith. Spacer ring 54a surrounds upper membrane boot 44.

FIG. 3B is an expanded view of Detail 3B of FIG. 3 showing the module bottom flange 16, threads 33 on the outer diameter of center core 32 as well as threads 35 on the inner diameter of bottom boot 46. Threads 33 and 35 serve to increase the surface area of the outer diameter of center core 32 and the inner diameter of receiver 36 to improve engagement with the potting material 23, which in one embodiment may be epoxy or other thermoplastic materials, to provide a vacuum seal to prevent leakage.

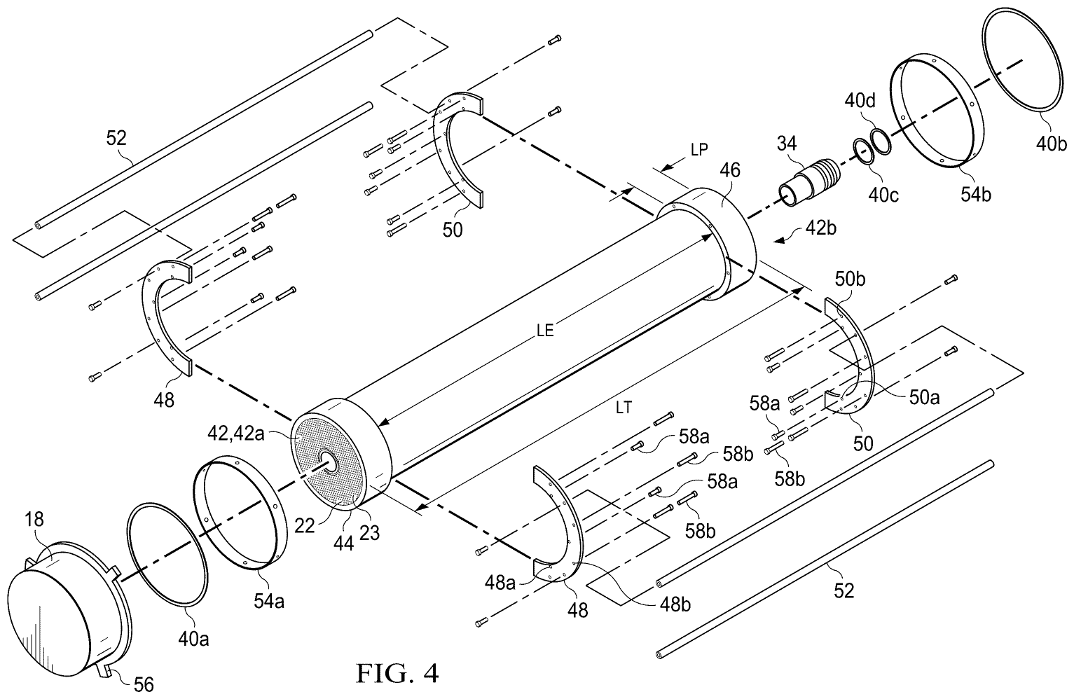

Referring to FIGS. 3, 3A, 3B, the shell 12 is, in one embodiment, a single cylindrical tube made of a thermoplastic capable of withstanding operating temperatures varying from 5° C. to 100° C. Shell 12 may alternatively comprise more than one component (not shown). Module top flange 14 provides for connection to a corresponding flange on a vapor collector header (not shown). The connection between the flanges is accomplished via interconnecting bolts 58 as seen in FIG. 4. One or more seals, such as gaskets, (not shown) between the flanges provide a seal under vacuum.

Referring to FIG. 3B, in similar fashion, module bottom flange 16 provides for connection to module bottom cap 20. The module bottom cap 20 receives fiber membrane bundle 22 and therefore serves as bottom cap of the membrane module.

The module bottom cap 20, may, in one embodiment, be manufactured from a single piece of thermoplastic. In one embodiment, module bottom cap 20 includes an industry standard 12″ flange 24 having the same bolt pattern as the module bottom flange 16. In one embodiment, the bottom end incorporates the hydraulic connections to the cap including the feed water inlet 26, the concentrate water outlet 28, and a seepage outlet 30. The feed water inlet 26 is fluidly connected to the center core 32 of the fiber membrane bundle 22.

Further referring to FIGS. 3 and 3B, the feed water inlet 26 is in one embodiment a standard 2″ male “Camlock” connection type. A series of seals (not shown) ensures the hydraulic integrity at the interface point of the module bottom cap 20 with the ends 32a and 32b of center core 32 of the fiber membrane bundle 22.

Liquid flowing out of the membrane fibers 42 is collected in the module bottom cap 20 and directed to the concentrate outlet 28 of the connector, which in one embodiment is a 2″ male “camlock” connection type. A series of seals 40b, 40c, 40d, ensures the hydraulic integrity at the interface point of the fiber membrane bundle 22 with the module bottom cap 20 and concentrate outlet 28.

The seepage outlet 30 is at the module bottom cap 20 of the fiber membrane bundle 22. Any liquid that should pass through the membrane is collected and returned to a seepage tank (not shown) of the process via the seepage outlet 30, which in one embodiment is of the 1″ male “camlock” connection type.

Male “camlock” connections for feed water, concentrate and seepage correspond to female “camlock” connections which are typically by braided hose or rubber hose but may also be a hard-piped connection.

The module bottom cap 20 comprises a receiver 36 for a fiber membrane bundle 22 having, one embodiment, an approximate diameter of 8″. The receiver 36 is designed to accommodate complete vacuum. Receiver 36 is at the center of the module bottom cap 20, and is, in one embodiment, a female connection region for the fiber bundle 20 which is approximately 150 mm in diameter. Central to the receiver for the fiber bundle is an end core receiver 38 for receiving a center core end connector 34 of fiber membrane bundle 22.

As seen in FIG. 3B, receiver 36 is equipped with two “O” ring seals 40c and 40d around its inner circumference. Stated differently, O-rings 40c and 40d fit into chamfers on the outer diameter of center core connector 34. These O-rings are designed to ensure that vacuum integrity and hydraulic integrity are maintained and that the fiber membrane bundle 22 is securely seated. A gasket 37 is provided to impart a vacuum seal the module bottom cap 20 to the module bottom flange 16.

FIG. 4 is an exploded view of the hollow fiber membrane bundle of FIG. 3 in which a plurality of hollow fiber membranes 42, depicted collectively as fiber membrane bundle 22, is disposed between top and bottom membrane boots 44, 46, which may also be called “membrane boots.” The ends 42a, 42b, of the hollow fiber membranes 42 are secured to the membrane boots 44, 46 by chemical bonding with a potting material 23. Potting material 23 may be a thermoplastic polymer that is used to secure the ends of the plurality of hollow fiber membranes 42 to the membrane boots. Each membrane boot 44, 46 has a bundle flange 48 (top), 50 (bottom). Bundle flanges 48, 50 fit “inboard” of the membrane boots 44, 46. That is, upper bundle flange 48 fits to the bottom end of upper membrane boot 44, while lower bundle flange 50 fits to the top end of lower membrane boot 46. In line with the preceding sentence, supporting rods 52 (one or more, with four depicted in FIG. 4), are secured at each end to the respective bundle flanges 48, 50 and provide structural support to (that is, they act to provide longitudinal tension to) the fiber membrane bundle 22. In one embodiment, each of the bundle flanges 48, 50 comprises two halves, for ease of assembly. It is seen that bundle flanges 48, 50 include two concentric rings of apertures 48a and 50a, to accommodate two sets of bolts (generally 58) for two different purposes. For example, the inner ring of apertures 48a defined in bundle flange 48 accommodates bolts 58a to attach bundle flange 48 “up” to upper membrane boot 44. The outer ring of apertures 48b defined in bundle flange 48 accommodates a different set of bolts 58b to attach bundle flange 50 “down” to supporting rods 52.

Center core 32, best seen in FIGS. 3, 3B, runs up the center of the fiber membrane bundle 22. Referring to FIG. 4, a center core connector 34 provides a fluid connection for feed water to enter center core 32 from the feed water inlet 26 of the module bottom cap 20. A module top cap 18 is sealingly attached to the top membrane boot 44. Center core 32 transmits feed water from inlet 26 of module bottom cap 20 to the module top cap 18 where it is distributed to the hollow fiber membranes 42 for return flow down the interior (lumen) (not shown) of the hollow fiber membranes 42. In some embodiments, the feed water may be provided to the exterior of the hollow fiber membranes 42. A spacer ring 54a disposed between the top bundle flange 48 and the module top cap 18 assists with engagement and sealing of module top cap 18. The inner surface of the spacer ring has a chamfer 39 at one edge to seat an O-ring 40a. Another spacer ring 54b assists engagement and sealing of the bottom membrane boot 46 with the module bottom cap 20, as seen in FIG. 4. Projections 56 extending radially from the module top cap 18 are dimensioned to approach or abut the inner circumference of the module shell 12, thereby locating and supporting the membrane element in proper axial orientation and protecting the fiber membrane bundle 22 from malfunction or damage resulting from lateral movement within the shell 12.

Flow of vapor around the membrane fibers 42 is influenced by the packing density of the fibers. The packing density of the fiber membrane bundle 22 is engineered for optimal performance for the intended application. Water vapor passing through the hollow fiber membranes 42 can exit the fiber membrane bundle 22 into space S between the outer circumference of the fiber membrane bundle 22 and the inner surface of the module shell 12 and is extracted under vacuum through a vapor header (not shown).

As seen in FIG. 4, the effective membrane length LE, as shown in FIG. 4, is the length of a fiber bundle, between top membrane boot 44 and bottom membrane boot 46, that contributes to vapor production. Total membrane bundle length, LT, refers to the total length of a membrane bundle, including LE, the length of module bottom cap 20 including, in one embodiment, bundle inlet camlock connector 26, plus the length (LP) of two membrane boots 44, 46. In one embodiment, the distance LE is about 70 cm, and may be about 80 cm, about 90 cm, about 100 cm about 110 cm, 120 cm or other values in between. In one embodiment, the length LP is about 5 cm, about 10 cm, about 15, cm, about 20 cm, about 25 cm or other values in between.

It has been determined that the performance of the seal between the potting material 23 and the center core 32 or between the potting material 23 and the membrane boots 54a, 54b can be greatly enhanced by a design in which end sections of the center core 32 are adapted for enhanced bonding with potting materials 23.

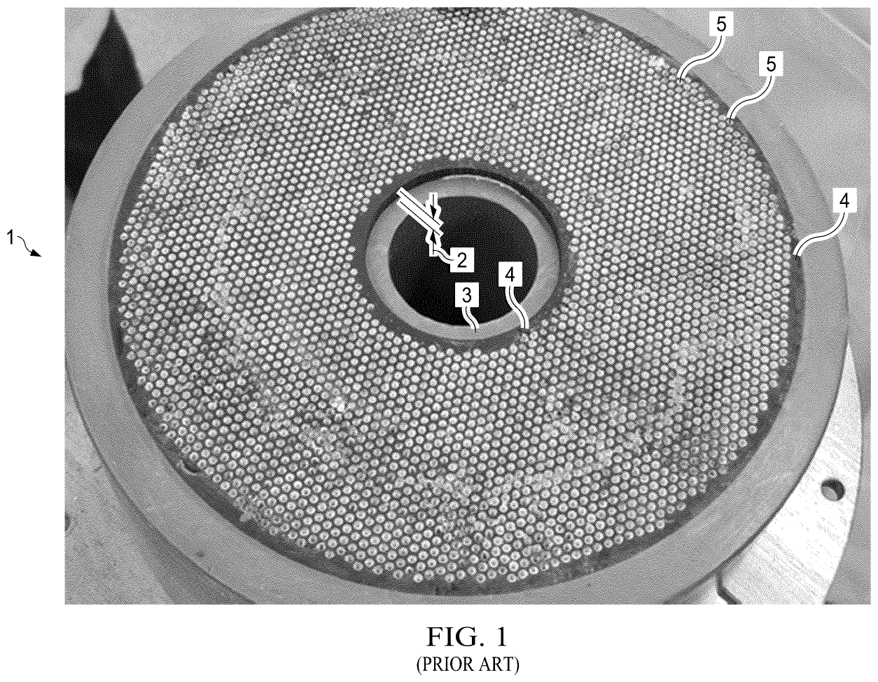

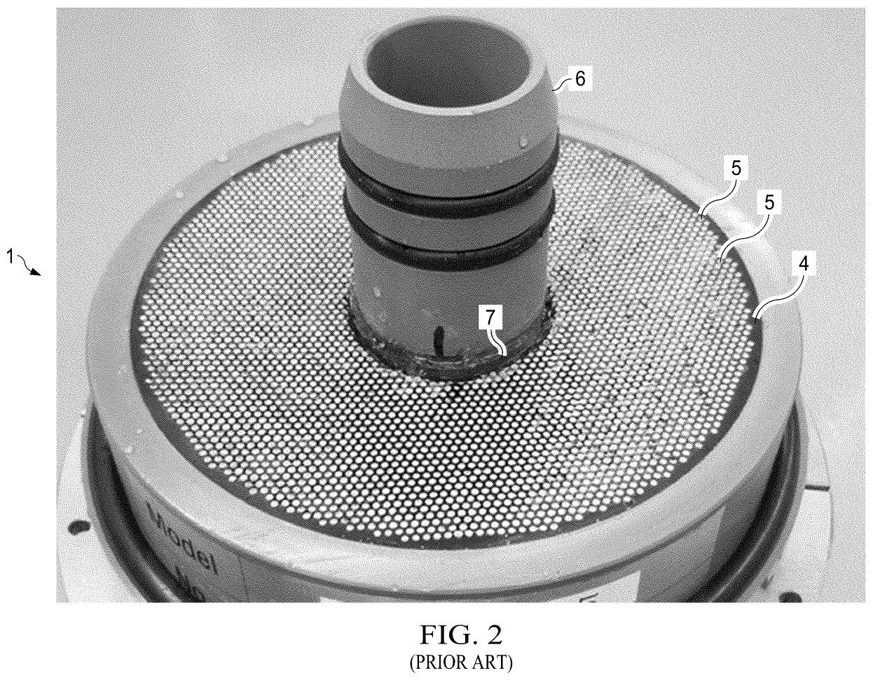

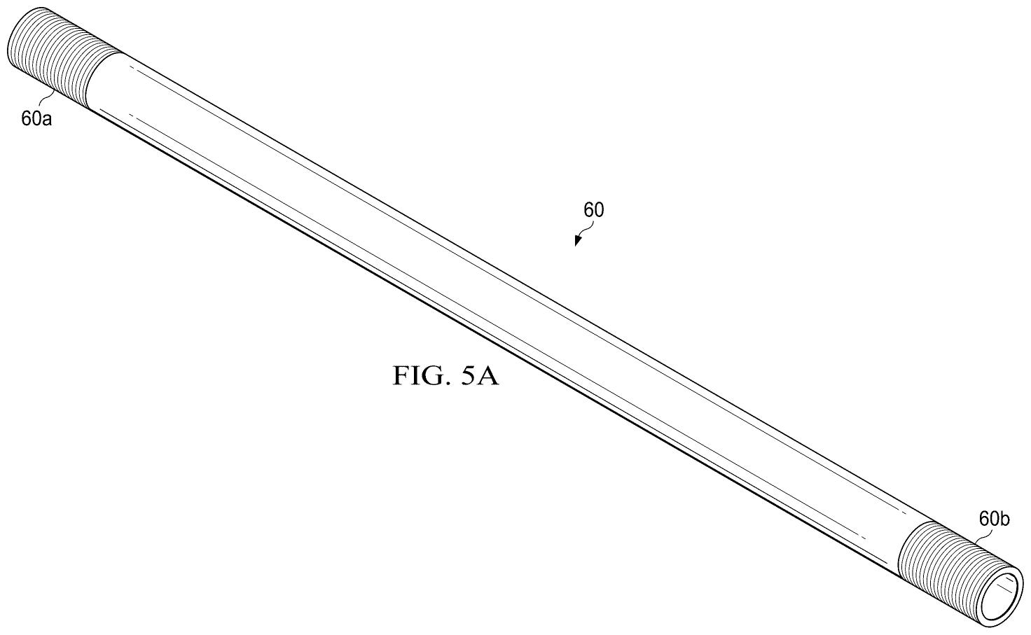

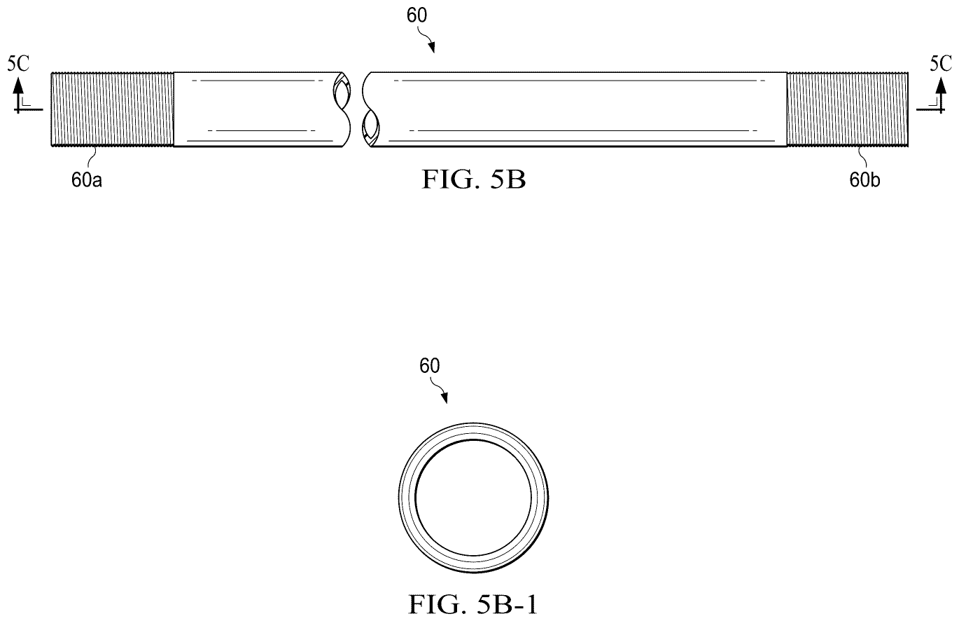

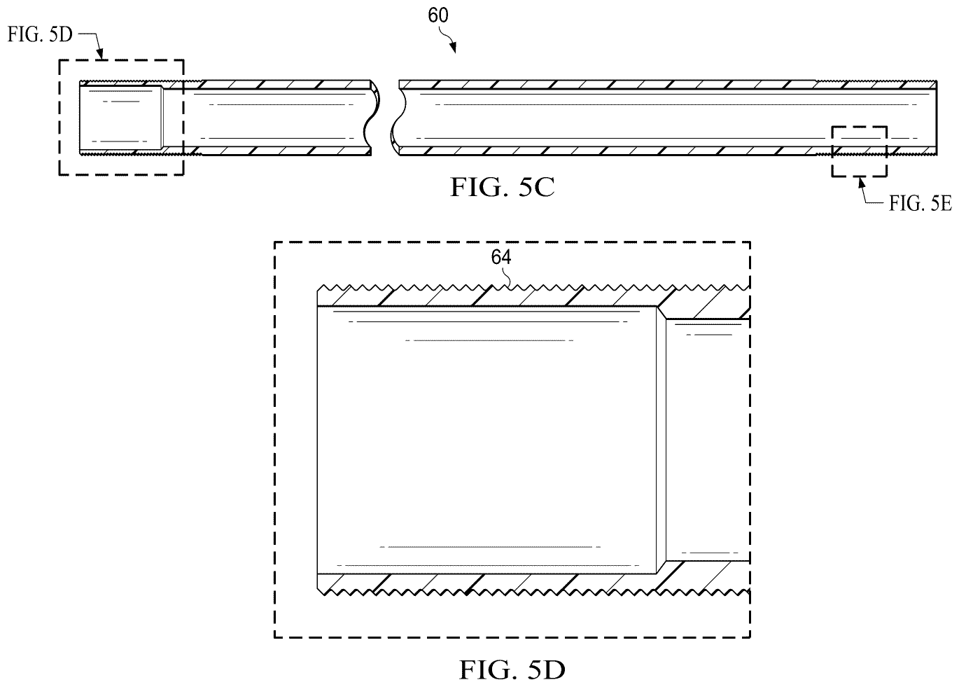

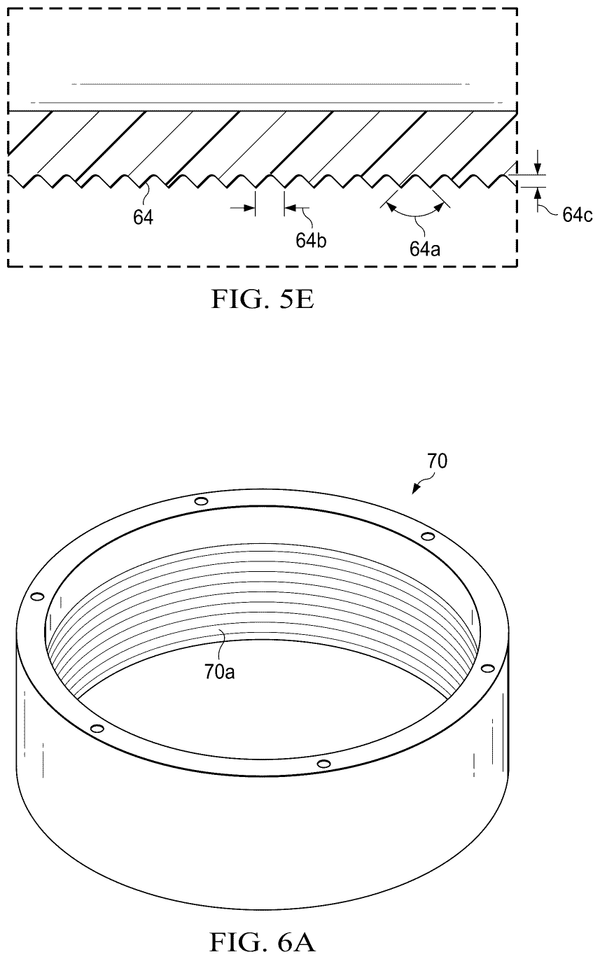

FIGS. 5A-5E depict a center core 60 according to the disclosure, with a threaded outer surface 60a, 60b at each end of the center core 60. FIG. 5A provides a perspective view of a threaded center core 60 according to the disclosure. FIG. 5B is a plan view of a center core of the disclosure. FIG. 5B-1 is an end view of the center core of FIG. 5B. FIG. 5C is a section along C-C of the top plan view. FIG. 5D is Detail D of FIG. 5C showing a threaded end of the section. FIG. 5D includes item 60d in particular threads 64a on the outer diameter of enter core 60.

FIG. 5E includes Detail 5E, of FIG. 5C, showing an expanded view of threads 66 and associated features. FIG. 5E depicts individual threads 66 in terms of pitch angle 66a, thread width 66b and thread depth 66c. In one embodiment, these dimensions may be on the order of 0.1 to 3 mm.

In one embodiment, center core 60 may take the place of center core 32 as shown in FIG. 3. Threads 60a and 60b serve to engage potting material 23, the foregoing also shown in FIGS. 1A and 1B.

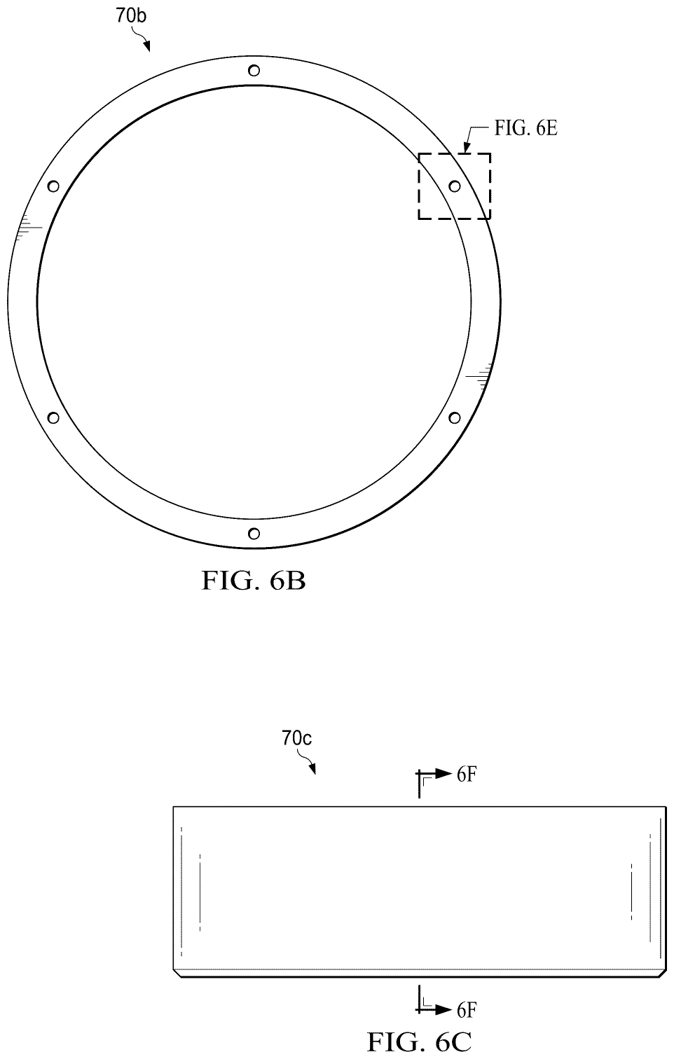

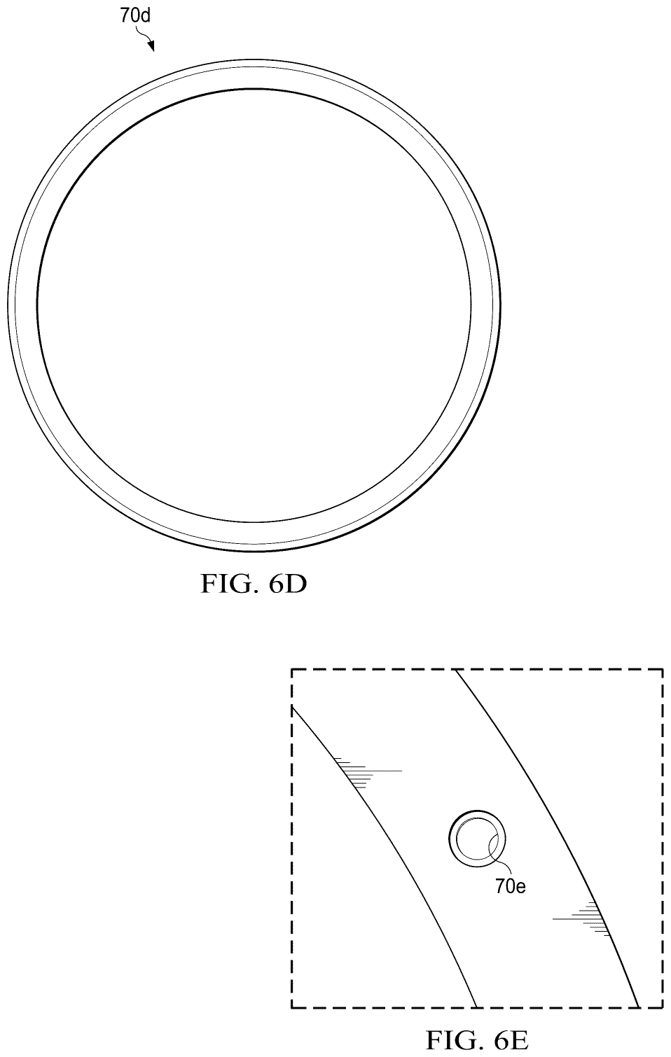

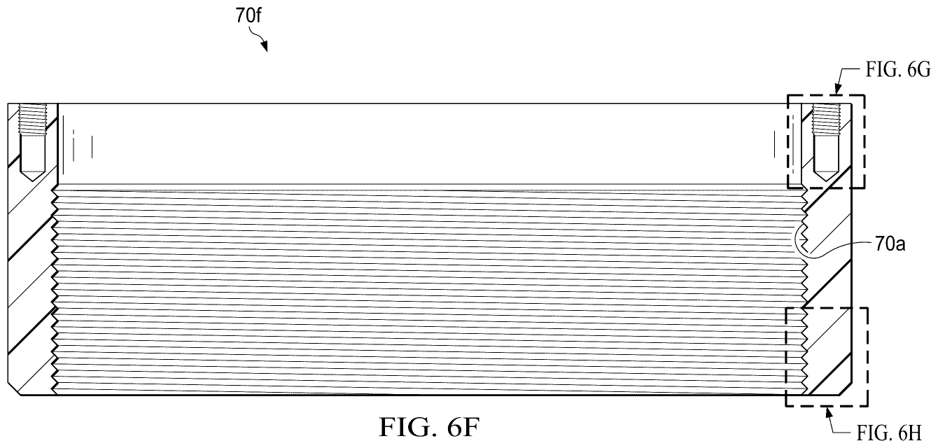

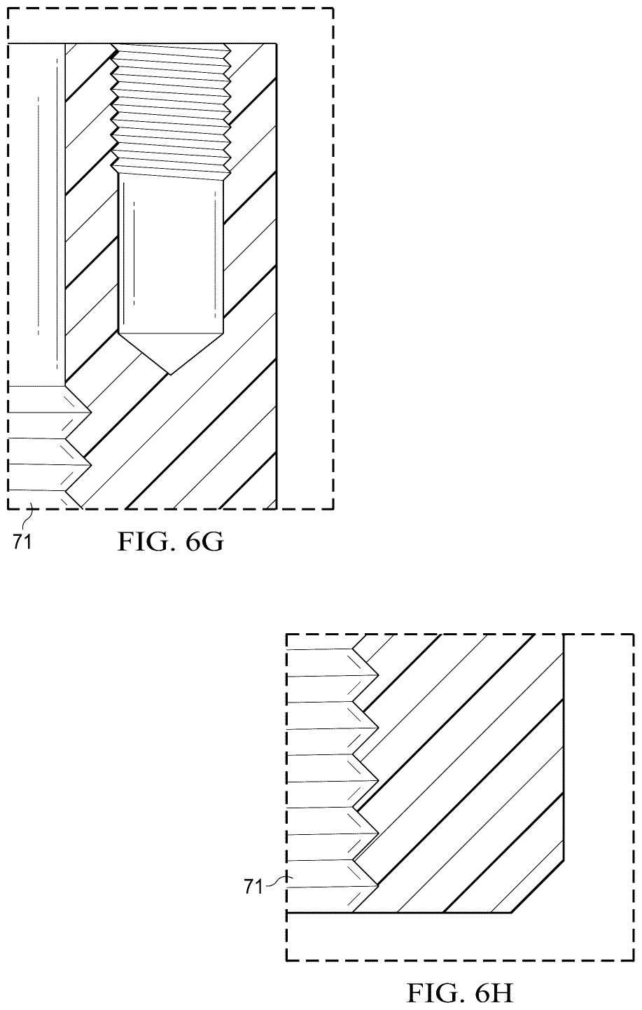

FIGS. 6A-6H show a modified membrane boot. In particular, FIG. 6A shows a membrane boot 70 in which threads 70a have been applied to the inner diameter of ring 70. The ring 70 forms the outer circumference of the a membrane boot (for example item 44 or 46) and contains the potting material 23. The threads 70a provide a ridged profile for increased engagement with the potting material 23 and a greater surface area for adhesion of the potting material 23 to the ring 70, which is equivalent to rings 54a and 54b.

FIG. 6B is a top plan view of ring 70 showing Detail D, which is an aperture 70e, through the threads 70a. FIG. 6C is a side view of ring 70 having cross section 6F-6F. FIG. 6D is a bottom view of ring 70. FIG. 6E is an expanded view of detail D from FIG. 6B, and features an aperture 70e. FIG. 6F is a sectional view along line 6F-6F in FIG. 6C. FIG. 6G is an expanded view of detail G from FIG. 6F showing threads 70a for increased engagement between potting material 23 and the inner circumference of bottom membrane boot 46. FIG. 6H is an exploded view of detail H from FIG. 6F showing threads through the ring in a vertical or longitudinal direction.

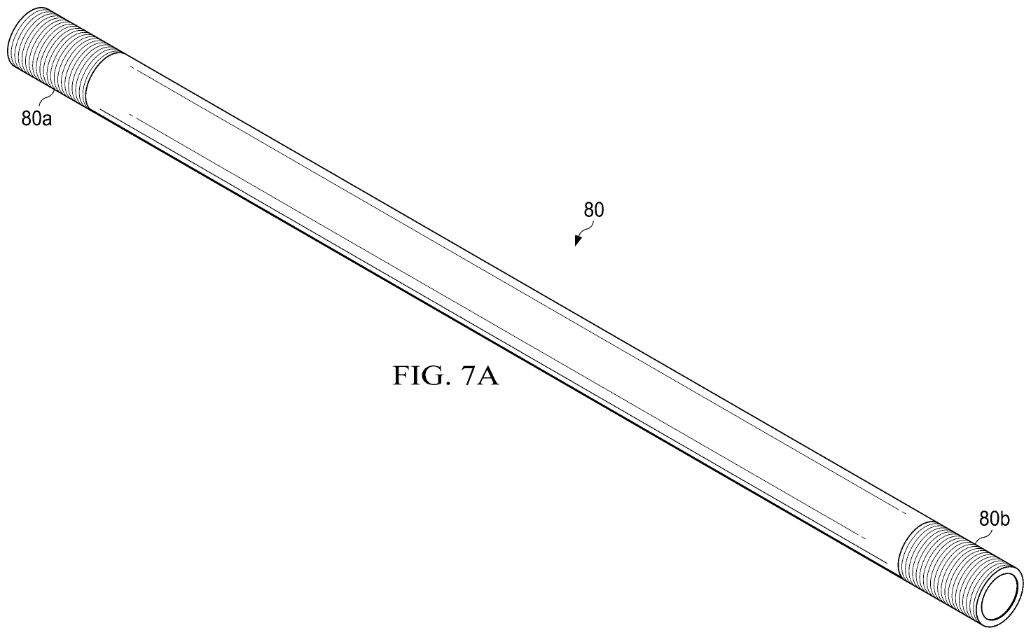

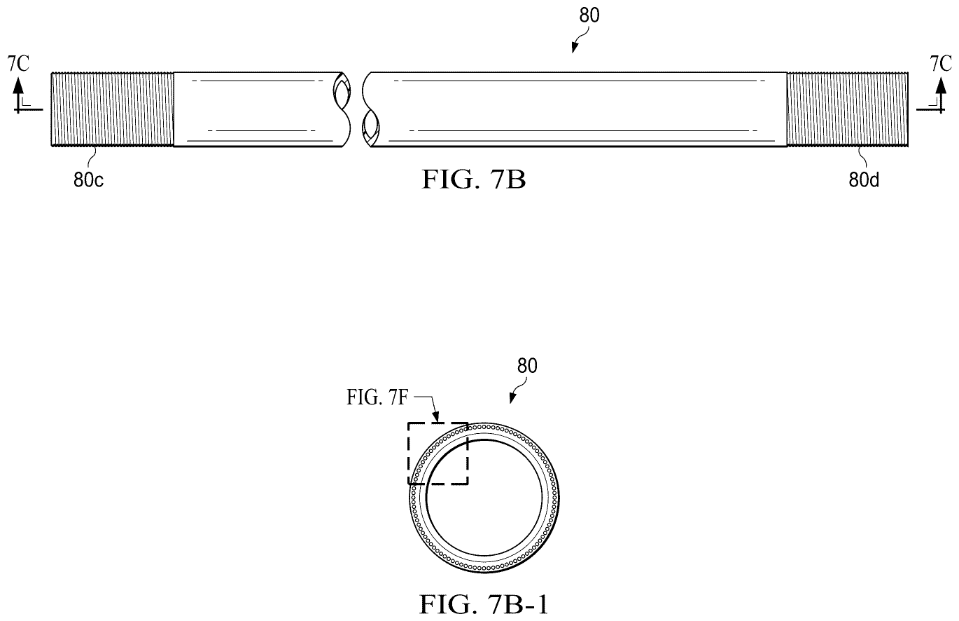

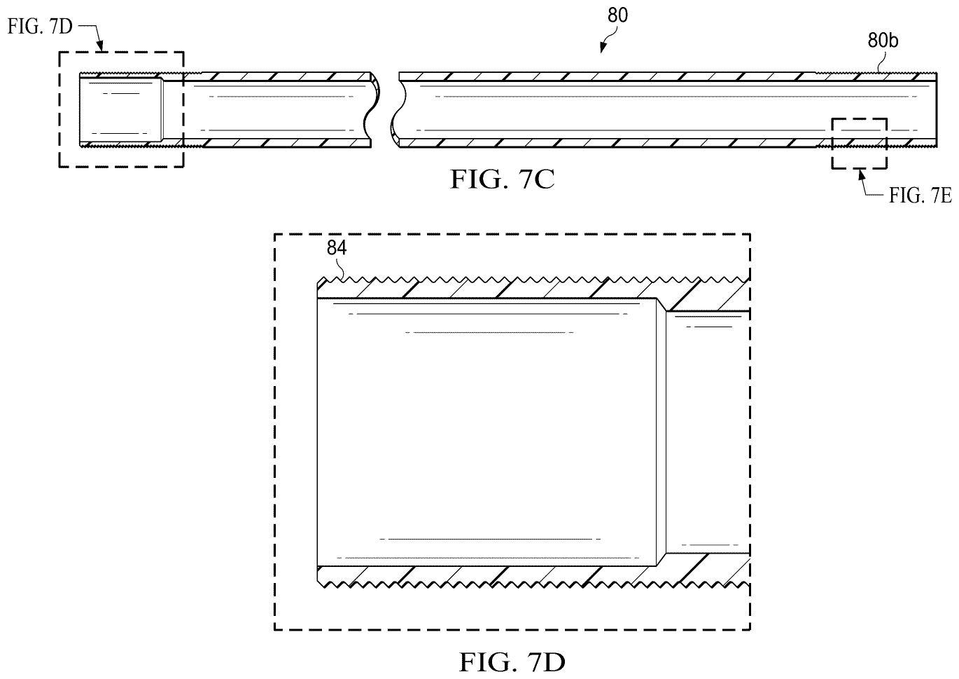

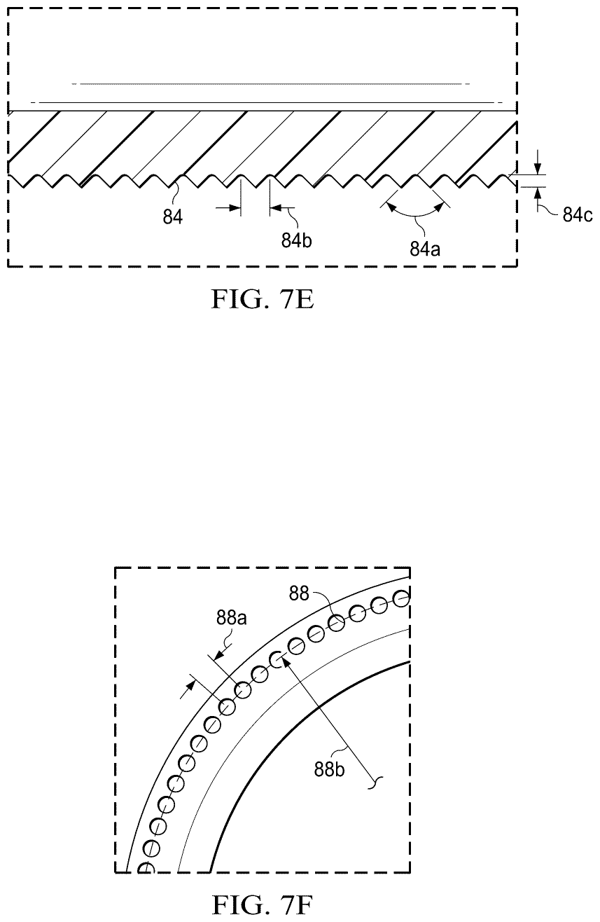

FIGS. 7A-7F show further disclosed embodiments in which threaded portions 80a, 80b of center core 80 are formed with apertures 88 in threads 84 (FIG. 7F) to further increase engagement of the potting material 23 with the center core 80 by facilitating penetration of the potting material 23 and increasing surface area for contact. In this embodiment, as seen in FIG. 7F, apertures 88 are disposed at intervals in threads 84 along the entire longitudinal dimension of threads 84. This produces threads 84 with apertures 88 where potting material 23 and thermoplastic material of the center core 80 are interlocked. Other arrangements of apertures may be envisaged to achieve the desired interlocking effect.

In detail, FIG. 7A is a perspective view of a threaded center core 80 according to the disclosure. FIG. 7B is a side elevation of center core 80 and includes cross section 82 showing Detail 7F which forms FIG. 7F. FIG. 7C is a section along line 7C-7C of the side elevation in FIG. 7B. FIG. 7D is Detail 7D of FIG. 7C showing a threaded end of the section 80a with threads 84. FIG. 7E shows Detail 7E of FIG. 7C which is an enlarged view of a threaded part in a sectional view, where individual threads 84 are shown in terms of pitch angle 86a, thread width 86b and thread depth 86c. The pitch angle dimension 86a may be on the order of 45-135°, or 60-120° or 75-105, or about 90°. These dimensions may be on the order of 0.1 to 3 mm for thread width 86b and thread depth 86c. FIG. 7F shows apertures 88 piercing through threads 84 (FIG. 7D) in the longitudinal direction. Apertures 88 have an angular spacing dimension which in one embodiment is about 2-4° of arc, and a radius 88b which in one embodiment is about 1.5-2″.

In one embodiment, center core 80 (FIG. 7A) may take the place of center core 32 as shown in FIG. 3. Threads 84 serve to engage potting material 23, the foregoing also shown in FIGS. 1A and 1B.

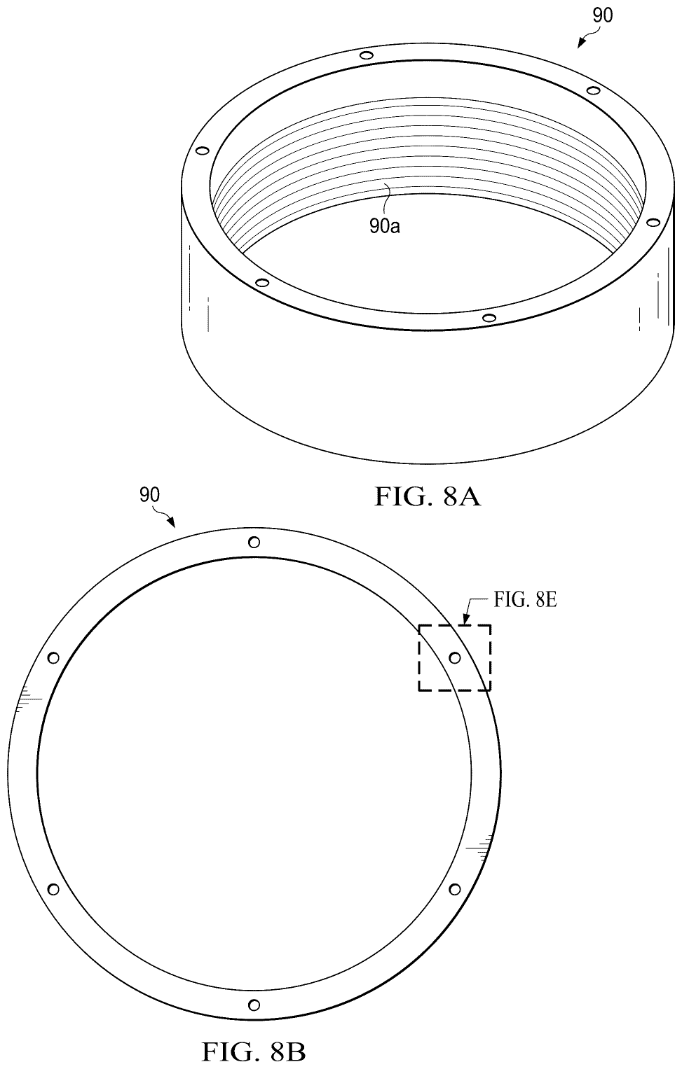

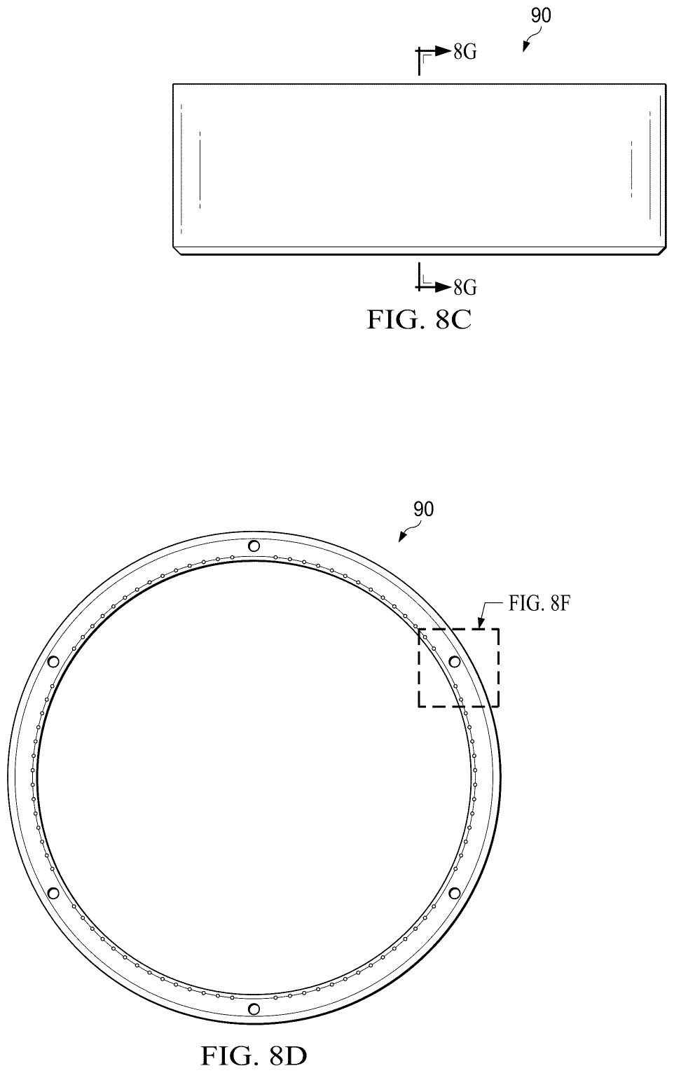

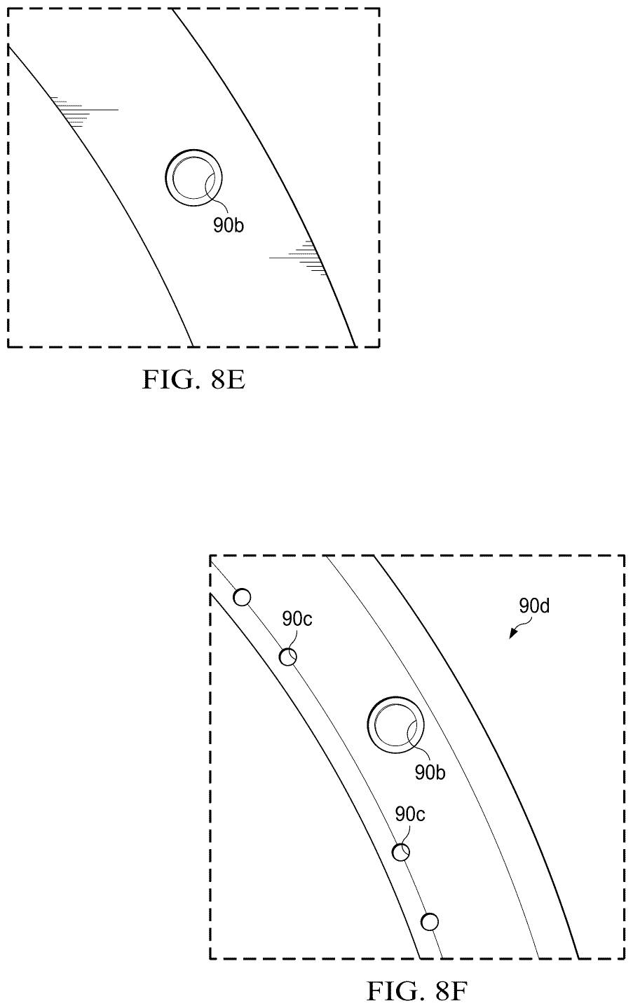

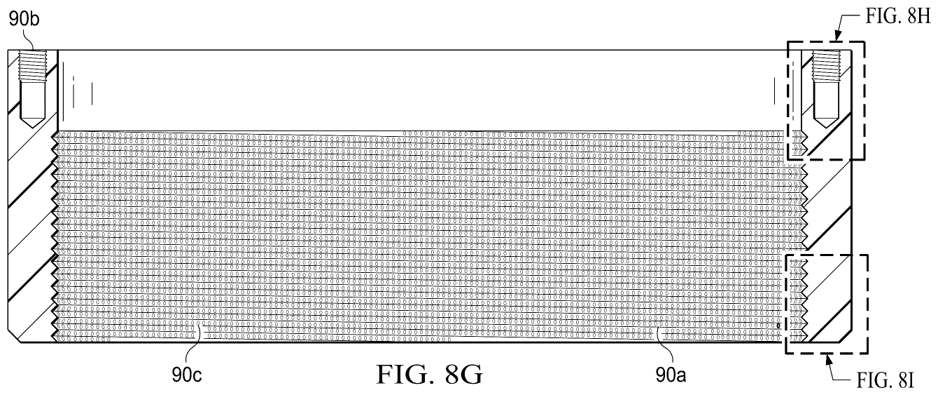

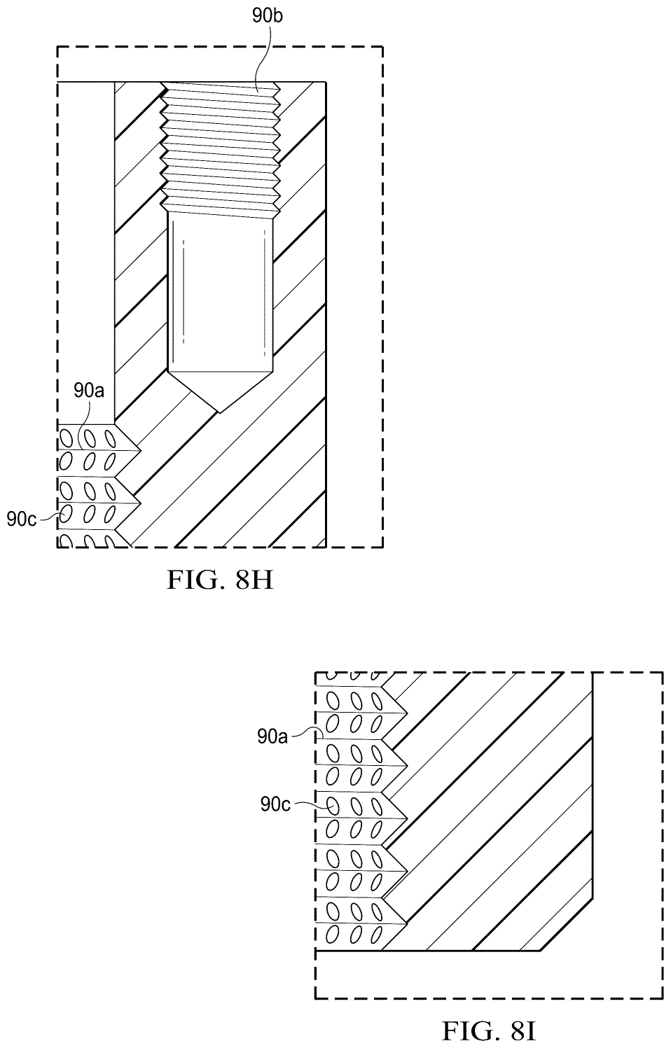

FIGS. 8A-8I depict a modified membrane boot 90. In particular, FIG. 8A shows a membrane boot 90 in which threads 90a have been applied to the inner diameter of ring 90. Ring 90 forms the outer circumference of the a membrane boot 44, 46, and contains the potting material 23. The threads 90a provide a ridged profile for increased engagement with the potting material 23 and a greater surface area for adhesion of the potting material 23 to the ring 90. FIG. 8B is a top plan view of ring 80 showing detail 8E, which is an aperture 90e, through the threads 90a. FIG. 8C is a side view of ring 90 having cross section 8G. FIG. 8D is a bottom view of ring 90. FIG. 8E is an expanded view of detail 8E from FIG. 8B, and features an aperture 90e. FIG. 8F is an expanded view of detail 8F in FIG. 8D, which is an aperture 90d-1. FIG. 8G is an exploded view of detail 8G from FIG. 8C showing threads in an inner diameter of the ring 90. FIG. 8H is an exploded view of detail 8H from FIG. 8G showing threads through the ring 90.

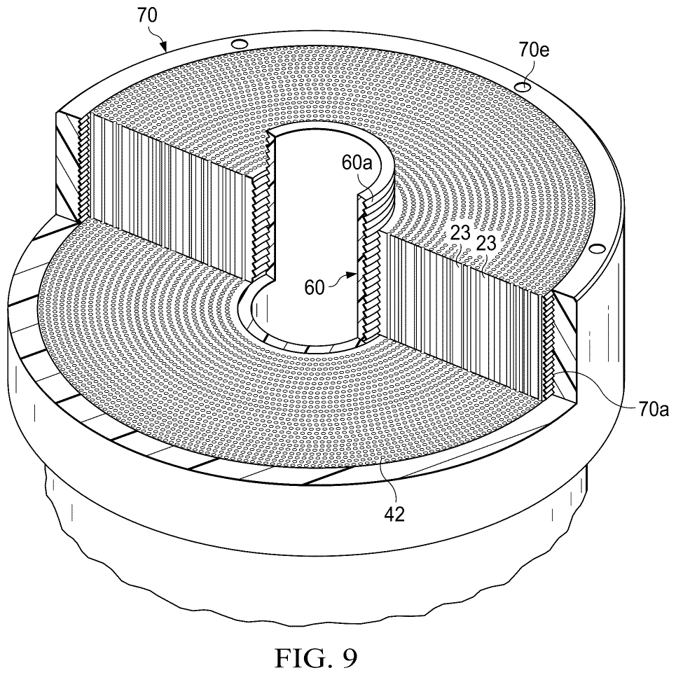

FIG. 9 is partial sectional view of a membrane bundle showing center core 60 having threads 60a on an outer surface thereof together with membrane boot 70 having threads 70a on an inner surface thereof. Hollow fiber membranes 42 are potted with potting material 23. The threads 60a, 70a establish interlocking between potting material 23 and membrane boot 70 (made of and CPVC or similar thermoplastic materials) and with center core 60, which may be made of similar materials. Potting material 23 fills up threads 60a and 70a. Any center core (such as 80—FIG. 7A) or membrane boot (such as 90—FIG. 8A) disclosed herein (e.g., those with apertures as well as threads) may substitute for center core 60 or membrane boot 70.

In an alternate embodiment, and apertures 88 (best shown in FIG. 7F or 8G) on the surface of the membrane boot 44 and the threads and apertures (70, 70a or 90, 90a) on the surface of the center core 32, forming a strong bond between the potting material 23, the center core 32 and the membrane boot 44 and thus providing a robust and durable seal between the component parts.

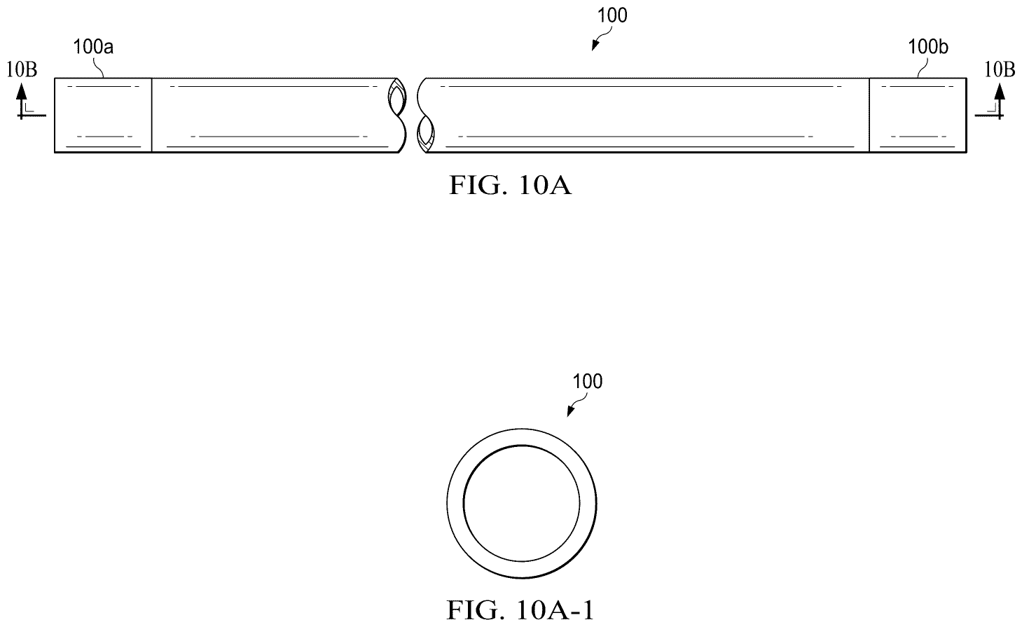

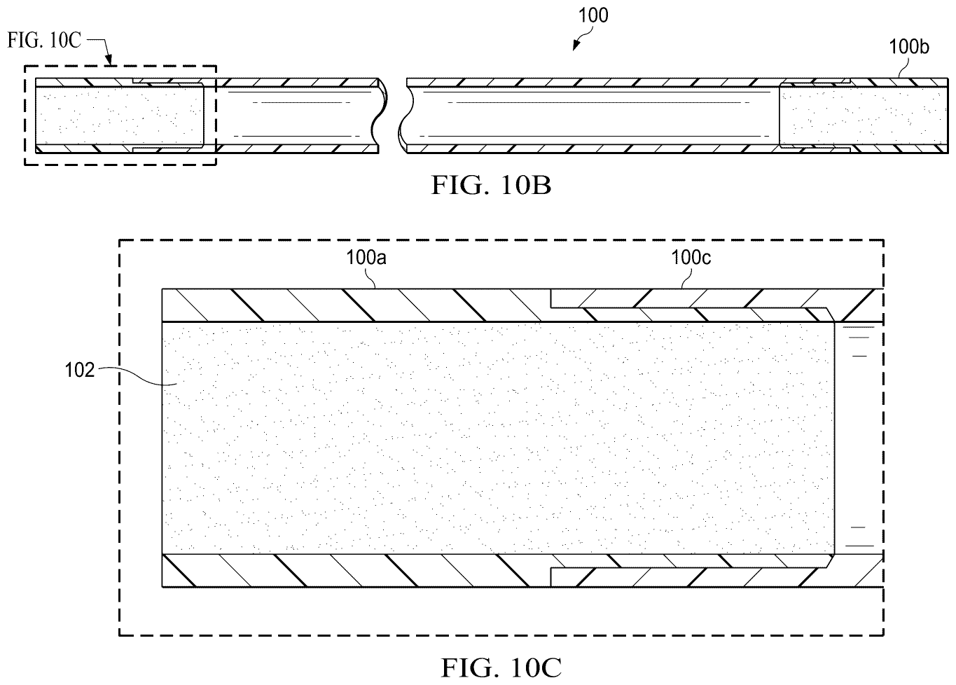

FIGS. 10A-10C show further disclosed embodiments of the invention. FIG. 10A shows end portions 100a, 100b of center core 100 coated with porous thermoplastic material 102 (also shown by stippling) to further increase engagement of the potting material 23 with the center core 100 by facilitating penetration of the potting material 23 (not shown in FIG. 10) and increasing surface area for contact. In this embodiment, as seen in FIGS. 10B and 10C, porous thermoplastic material 102 is disposed along the exterior of the ends of center core 100 as seen in detail 10C of FIG. 10B. This produces ends 100a, 100b, of center core 100 where potting material 23 and porous thermoplastic material 102 are interlocked. The beneficial effect of porous material 102 providing a strong bond with potting material 23 may be achieved in the absence of threads and/or apertures. Porous material 102 may in this embodiment take the place of, and perform a similar function as, threads and/or apertures. FIG. 10C also shows that an end portion 100c of the center core 100 can be formed of a porous thermoplastic material 102 which is glued to the main body 100c of the center core 100.

In one embodiment, center core 100 may take the place of center core 32 as shown in FIG. 3. Porous thermoplastic material 102 serves to engage potting material 23, the foregoing also shown in FIGS. 1A and 1B. In one embodiment, no threads or apertures are required to obtain a good seal.

Reviewing FIGS. 5, 6, 7, 8, 9 and 10 it is noted that the center cores of FIGS. 5A through 5E, FIGS. 7A through 7F and FIGS. 10A through 10C are interchangeable with one another and with center core 32. Further, it is noted that the membrane boots of FIGS. 6A through 6H and 8A through 8I are interchangeable with one another and with membrane boots 44 and 46.

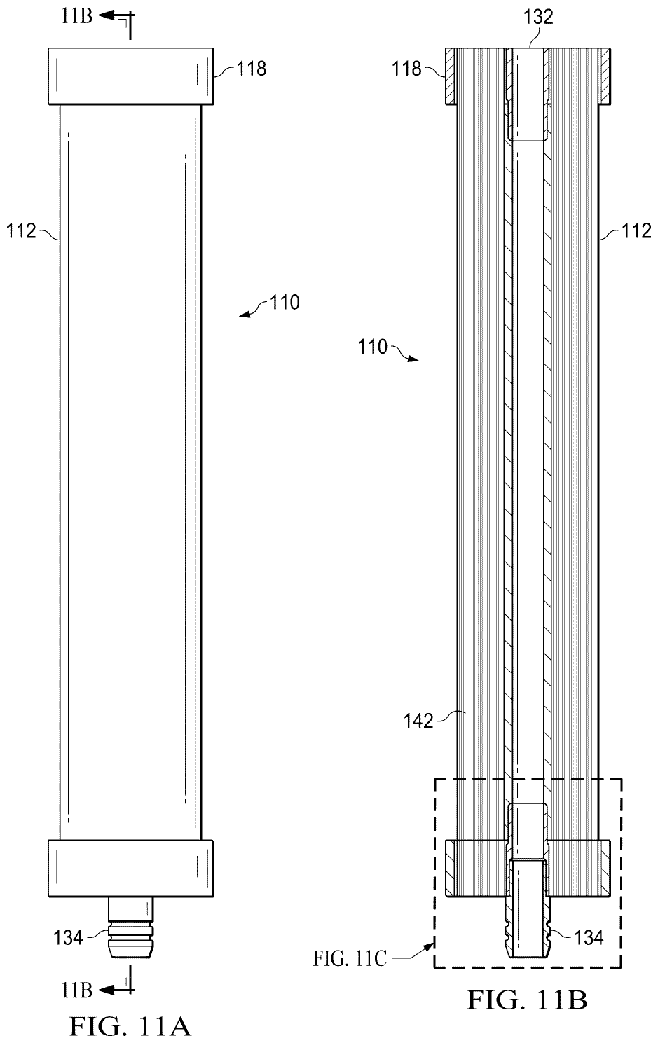

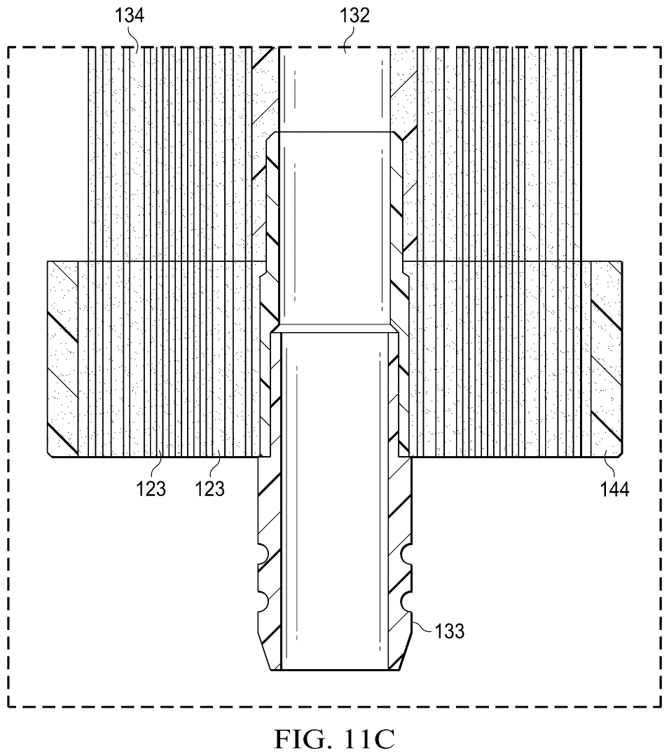

FIG. 11 is a depiction of an embodiment in which the center core 132 and the center core end connector 134 and the lower membrane boot 144 are formed of porous thermoplastic. That is, the components are formed from porous thermoplastic instead of being coated with a porous thermoplastic such as in FIG. 10C. FIG. 11, Detail 11C, shows the inside face of the bottom membrane boot 144 and the outside face of the center core 133 and center core end connector 134 formed of porous thermoplastic (shown by stippling in FIG. 11C). Potting material 123 penetrates the porous thermoplastic forming a strong bond between the potting material 123, the center core 132 and the retaining ring 144 and thus provides a robust and durable seal between the component parts.

In one embodiment, center core 132 made of porous thermoplastic material, may take the place of center core 32 as shown in FIG. 3. Porous thermoplastic center core 132 serves to engage potting material 23, the foregoing also shown in FIGS. 1A and 1B.

### Leakage Test Procedure

Boots and center core parts were threaded as described above. The membrane fibers 42 were potted with potting material 23 between membrane boots 44 and 46 and the center core 32. The insides of the membrane boots 44, 46 were threaded with threads 35. The two ends 32a, 32b of the center core 32 were threaded all the way through the potting material (FIG. 9, center core 60, threads 60a, potting material 23). The membrane bundles 22 were tested using a testing apparatus where bundles are installed tightly with a perfect seal. Then the water introduced outside of fibers with 100 kPa pressure. If any there were any leakages from a broken fiber, compromised sealing between fibers and around the boots and center core could be observed from the two sides of the bundle. This is the maximum hydraulic and vacuum pressures to which the system will be exposed.

### Test Results

TABLE 1
Leakage test results

| Membrane Code: PTFE PMX-485 | | | |
|---|---|---|---|
| | Surface Area | Membrane | Leakage at 100 |
| Bundle No. | m2 | Mm | ml |
| 230001 | 9.6 | 958 | No Leakage |
| 230002 | 19.6 | 958 | No Leakage |
| 230003 | 9.6 | 958 | No Leakage |
| 230004 | 9.6 | 958 | No Leakage |
| 230005 | 9.6 | 958 | No Leakage |
| 230006 | 9.7 | 958 | No Leakage |

All bundles showed zero leakages.

1. A vacuum membrane distillation module comprising:
an elongate center core having a first longitudinal axis;
a plurality of elongate hollow fiber membranes having a second longitudinal axis substantially coaxial with, or substantially parallel to, the first longitudinal axis of the elongate center core;
at least one circumferential retaining structure that retains a potting material and at least one end of the plurality of elongate hollow fiber membranes;
wherein the at least one end of the plurality of elongate hollow fiber membranes are secured in the potting material;
at least one end cap retaining the at least one circumferential retaining structure;
wherein the potting material is contained between (i) an inner boundary formed by an outer surface of the elongate center core, and (ii) a peripheral boundary formed by an inner surface of the at least one circumferential retaining structure;
an elongate shell which cylindrically houses an elongate bundle of hollow fiber membranes and the elongate center core;
wherein the elongate shell has a third longitudinal axis substantially coaxial with, or substantially parallel to, the first longitudinal axis of the elongate center core; and
wherein at least one of (i) the outer surface of at least one end of the elongate center core and (ii) the inner surface of the at least one circumferential retaining structure, comprise an adaptation to enhance bonding with the potting material.

2. A vacuum membrane distillation module comprising:
an elongate center core having at least one end section;
at least one circumferential retaining structure;
at least one end cap;
at least one supporting rod engaged with the at least one end cap to provide mechanical stiffness in a longitudinal direction;
a potting material, wherein the potting material is contained between (i) an inner boundary formed by an outer surface of the elongate center core, and (ii) a peripheral boundary formed by an inner surface of the at least one circumferential retaining structure;
a plurality of generally longitudinal hollow fiber membranes,
wherein ends of a plurality of hollow fiber membranes are secured in the potting material, and
wherein at least one of (i) the outer surface of the at least one end section of the elongate center core and (ii) the inner surface of the least one circumferential retaining structure comprises an adaptation to enhance bonding with the potting material.

3. The vacuum membrane distillation module of claim 2,
wherein the elongate center core, the plurality of hollow fiber membranes, the at least one end cap and at least one circumferential retaining structure all have substantially coincident or substantially parallel longitudinal axes.

4. The vacuum membrane distillation module of claim 1, wherein the potting material is an epoxy material.

5. The vacuum membrane distillation module of claim 1, wherein the adaptation comprises at least one of threads and apertures.

6. The vacuum membrane distillation module of claim 1, wherein the adaptation comprises threads and apertures.

7. The vacuum membrane distillation module of claim 6, wherein the adaptation comprises threads and apertures, wherein the apertures perforate the threads.

8. The vacuum membrane distillation module of claim 7, wherein the apertures are generally perpendicular to the threads.

9. The vacuum membrane distillation module of claim 8, wherein the peripheral boundary formed by the inner surface of the at least one circumferential retaining structure comprises a membrane boot.

10. The vacuum membrane distillation module of claim 1, wherein the least one circumferential retaining structure is a shell or a vessel of the vacuum membrane distillation module.

11. The vacuum membrane distillation module of claim 1, wherein the plurality of hollow fiber membranes is housed in a membrane bundle assembly that is removable from the vacuum membrane distillation module and wherein the least one circumferential retaining structure is a membrane boot.

12. (canceled)

13. The membrane bundle for a vacuum membrane distillation module of claim 2, wherein the adaptation is at least one of apertures and threads.

14. The membrane bundle for a vacuum membrane distillation module of claim 13, wherein the adaptation is comprises apertures and threads.

15. The membrane bundle of claim 14, wherein the potting material is an epoxy material.

16. The membrane bundle of claim 14, wherein the inner surface of the membrane boot is provided with apertures within a threaded surface.

17. A vacuum membrane distillation module comprising the membrane bundle of claim 14.

18. A method for making a hollow fiber membrane bundle for use in a vacuum membrane distillation module, the membrane bundle comprising a plurality of hollow fiber membranes having first ends and second ends, the hollow fiber membranes being secured at the first ends in a first membrane boot and at the second ends in a second membrane boot, wherein first membrane boot and second membrane boot comprise a potting material contained between an inner surface of a respective membrane boot and an outer surface of a central core, the method comprising:
a. provide the plurality of hollow fiber membranes;
b. extend the plurality of hollow fiber membranes in a longitudinal direction;
c. provide the first membrane boot and the second membrane boot;
d. provide a potting material;
e. arrange first membrane boot and second membrane boot and the plurality of hollow fiber membranes wherein the first membrane boot and second membrane boot contain the first and second ends of the plurality of hollow fiber membranes; and
f. wherein the first membrane boot and second membrane boot are at least partially filled with the potting material to secure the plurality of hollow fiber membranes within said first membrane boot and said second membrane boot.

19. The method of claim 18, further comprising: form at least one of the inner surface of the membrane boot and the outer surface of the central core with a conformation to increase engagement with the potting material.

20. The method of claim 19, wherein the conformation is selected from apertures, threads, and a coating comprising a porous material.

21. The method of claim 20, further comprising engaging the potting material with at least one of apertures and threads and a portion of membrane apertures to form bonded potting material through the at least one of apertures and threads.
